(19) United States
(12) Patent Application Publication
(10) Pub. No.: US 2026/0024102 A1
(43) Pub. Date: Jan. 22, 2026

(54) BUSINESS SUPPORT APPARATUS, BUSINESS SUPPORT METHOD, AND RECORDING MEDIUM

(71) Applicant: ProfinanSS Inc., Tokyo (JP)

(72) Inventors: Yoshihiro KIMURA, Tokyo (JP); Ryotaro MORIKATSU, Tokyo (JP)

(21) Appl. No.: 19/271,395

(22) Filed: Jul. 16, 2025

(30) Foreign Application Priority Data
Jul. 19, 2024 (JP) 2024-116084

(51) Int. Cl. G06Q 30/0201

(52) U.S. Cl. CPC G06Q 30/02011

(57) ABSTRACT

A business support apparatus includes: a parameter storage in which two or more business parameters regarding business are stored; a parameter acquiring unit that acquires business parameters input by a user and accumulates the business parameters in the parameter storage; a response acquiring unit that passes a prompt that is used to acquire a business parameter to generative AI, acquires a response containing the business parameter from the generative AI, and accumulates the business parameter in the parameter storage; a business plan acquiring unit that acquires business plan information on a business plan, using the business parameters in the parameter storage; and a business plan output unit that outputs the business plan information acquired by the business plan acquiring unit.

### CROSS REFERENCE TO RELATED APPLICATION

This application claims the benefit of priority of Japanese Patent Application Number 2024-116084, filed on Jul. 19, 2024, the entire content of which is hereby incorporated by reference.

### BACKGROUND OF THE INVENTION

### 1. Field of the Invention

The present invention relates to a business support apparatus and the like for supporting formulation of a business plan.

### 2. Description of Related Art

Conventionally, there have been business planning support systems for supporting the work involved in business planning conducted using data such as open data (see JP 2024-11875A).

Such a business planning support system includes a storage unit in which multiple pieces of region information, which is information indicating the configuration of a region, and multiple pieces of case study information, which is information on a case study of business planned for each region, are stored, wherein the system acquires an indicator for an issue that is to be solved by a business plan, extracts case study information with the common indicator from the case study information as recommended case study information, acquires a business evaluation item indicating business results from the recommended case study information, and generates and outputs information based on the business evaluation item. The business planning support system is a system that generates learning data in which one business evaluation item is taken as an objective variable and another business evaluation item is taken as an explanatory variable, based on the recommended case study information, generates an evaluation model trained with the learning data, and generates and outputs a value of the objective variable obtained by inputting a value of the business evaluation item of the business plan, as the explanatory variable, into the evaluation model.

JP 2024-11875A is an example of related art.

However, it has not been easy for conventional techniques to acquire proper business plan information.

A first aspect of present invention is directed to a business support apparatus, including: a parameter storage unit in which two or more business parameters regarding business are stored; a parameter acquiring unit that acquires one or more business parameters input by a user and accumulates the one or more business parameters in the parameter storage unit; a response acquiring unit that passes a prompt that is used to acquire a business parameter to generative AI, acquires a response containing the business parameter from the generative AI, and accumulates the business parameter in the parameter storage unit; a business plan acquiring unit that acquires business plan information, which is information on a business plan, using the two or more business parameters in the parameter storage unit; and a business plan output unit that outputs the business plan information acquired by the business plan acquiring unit.

With this configuration, it is easy to acquire business plan information by properly using the capabilities of generative AI.

Furthermore, a second aspect of the present invention is directed to the business support apparatus according to the first aspect, further including: a prompt template storage unit in which a prompt template is stored, the prompt template being information from which the prompt that is used to acquire a business parameter is configured; a unique information storage unit in which an explanatory business parameter identifier is stored in association with parameter identifiers for respectively identifying the two or more business parameters, the explanatory business parameter identifier identifying an explanatory business parameter, which is a business parameter that is used to acquire the business parameters identified with the parameter identifiers; a common information storage unit in which parameter common information, which is information common to the two or more business parameters, is stored; and a prompt acquiring unit that acquires a prompt, by acquiring, for each of the two or more business parameters, an explanatory business parameter identified with the explanatory business parameter identifier associated with the business parameter, from the parameter storage unit, placing the explanatory business parameter in the prompt template, and placing the parameter common information in the prompt template, wherein the response acquiring unit passes the prompt acquired by the prompt acquiring unit to the generative AI, acquires the response containing a business parameter from the generative AI, and accumulates the business parameter in the parameter storage unit.

With this configuration, it is possible to obtain a proper business parameter from generative AI by acquiring a proper prompt.

Furthermore, a third aspect of the present invention is directed to the business support apparatus according to the first or second aspect, wherein the response acquiring unit passes, to the generative AI, the prompt that is used to acquire a business parameter that is necessary for the business plan acquiring unit to acquire the business plan information and that cannot be acquired by the parameter acquiring unit, acquires the response containing the business parameter from the generative AI, and accumulates the business parameter in the parameter storage unit.

With this configuration, it is easy to acquire business plan information by properly using the capabilities of generative AI.

Furthermore, a fourth aspect of the present invention is directed to the business support apparatus according to the first or second aspect, wherein with respect to the business parameter acquired by the parameter acquiring unit, the response acquiring unit passes the prompt that is used to acquire the business parameter to the generative AI, acquires the response containing the business parameter from the generative AI, and accumulates the business parameter in the parameter storage unit.

With this configuration, it is easy to acquire business plan information by properly using the capabilities of generative AI.

Furthermore, a fifth aspect of the present invention is directed to the business support apparatus according to any one of the first to fourth aspects, wherein with respect to the business parameter acquired by the parameter acquiring unit, the response acquiring unit passes a prompt that is used to determine validity of the business parameter to the generative AI, and acquires a response regarding the validity from the generative AI, and the business support apparatus further includes a response output unit that outputs the response acquired by the response acquiring unit.

With this configuration, it is easy to acquire business plan information by properly using the capabilities of generative AI.

Furthermore, a sixth aspect of the present invention is directed to the business support apparatus according to the fifth aspect, wherein the response acquiring unit passes, to the generative AI, the prompt that is used to determine validity of only the business parameter that satisfies a validity determination condition among the business parameters acquired by the parameter acquiring unit, and acquires the response from the generative AI.

With this configuration, it is easy to acquire business plan information by properly using the capabilities of generative AI.

With the business support apparatus according to the present invention, it is easy to acquire business plan information by properly using the capabilities of generative AI.

### BRIEF DESCRIPTION OF THE DRAWINGS

FIG. 1 is a conceptual diagram of a business support system A in Embodiment 1.

FIG. 2 is a block diagram of the business support system A in the embodiment.

FIG. 3 is a block diagram of a business support apparatus 1 in the embodiment.

FIG. 4 is a flowchart illustrating an operation example of the business support apparatus 1 in the embodiment.

FIG. 5 is a flowchart illustrating an example of business parameter acquisition processing in the embodiment.

FIG. 6 is a flowchart illustrating an example of AI-powered parameter acquisition processing in the embodiment.

FIG. 7 is a flowchart illustrating an example of AI-powered validity determination processing in the embodiment.

FIG. 8 is a flowchart illustrating an operation example of a terminal apparatus 2 in the embodiment.

FIG. 9 is a diagram showing an example of a parameter definition management table in the embodiment.

FIG. 10 is a diagram showing an example of a parameter acquisition prompt template in the embodiment.

FIG. 11 is a diagram showing an example of a parameter validity determination prompt template in the embodiment.

FIG. 12 is a diagram showing an example of a unique information identifier management table in the embodiment.

FIG. 13 is a diagram showing an example of a common information management table in the embodiment.

FIG. 14 is a diagram showing an example of a parameter management table in the embodiment.

FIG. 15 is a diagram showing an example of an input screen in the embodiment.

FIG. 16 is a diagram showing an example of a parameter acquisition prompt in the embodiment.

FIG. 17 is a diagram showing an example of a response from generative AI in the embodiment.

FIG. 18 is a diagram showing an output example in the embodiment.

FIG. 19 is a diagram showing an example of a parameter acquisition prompt in the embodiment.

FIG. 20 is a diagram showing an example of a response from generative AI in the embodiment.

FIG. 21 is a diagram showing an output example of a PL in the embodiment.

FIG. 22 is a block diagram of a computer system in the embodiment.

### DETAILED DESCRIPTION OF THE INVENTION

Hereinafter, an embodiment of a business support apparatus and the like will be described with reference to the drawings. It should be noted that constituent elements denoted by the same reference numerals in the embodiments perform similar operations, and thus a description thereof may not be repeated.

### Embodiment 1

In this embodiment, a business support apparatus will be described that acquires business plan information using two or more business parameters and outputs the business plan information, the business support apparatus acquiring the business plan information using a business parameter acquired from generative AI.

Furthermore, in this embodiment, a business support apparatus will be described that configures a prompt using parameter common information and parameter unique information, and acquires a proper business parameter from generative AI, using the prompt.

Furthermore, in this embodiment, a business support apparatus will be described that specifies a missing business parameter in the case of acquiring business plan information, and acquires the missing business parameter from generative AI.

Furthermore, in this embodiment, a business support apparatus will be described that acquires a response from generative AI for an already acquired business parameter as well, and acquires business plan information using a business parameter selected by a user out of the two business parameters consisting of the already acquired business parameter and a business parameter contained in the response acquired from the generative AI.

Furthermore, in this embodiment, a business support apparatus will be described that requests generative AI to determine the validity of an acquired business parameter.

Moreover, in this embodiment, a business support apparatus will be described that requests generative AI to determine the validity of only some business parameters.

In this specification, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

Furthermore, in this specification, the selecting or determining information Z is to obtain the information Z, to obtain a pointer to the information Z, to obtain the ID of the information Z, to flag the information Z, or the like, and they may be any processing that makes the information Z accessible.

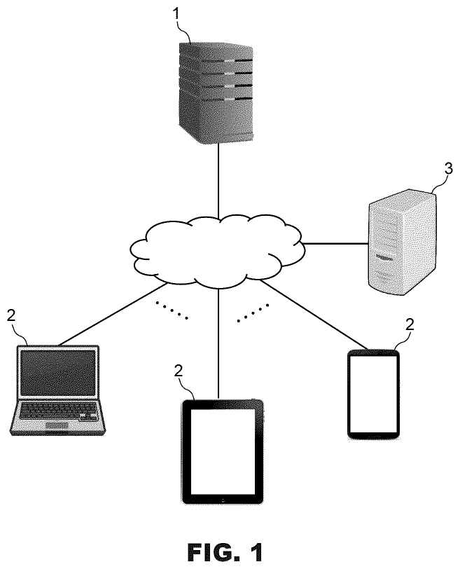

FIG. 1 is a conceptual diagram of a business support system A in this embodiment. The business support system A includes a business support apparatus 1, one or two or more terminal apparatuses 2, and a generative AI apparatus 3.

The business support apparatus 1 is, for example, a cloud server or an ASP server, but there is no limitation on the type thereof. The business support apparatus 1 may be a terminal. If the business support apparatus 1 is a terminal, the business support system A does not need the terminal apparatuses 2 or the business support apparatus 1 may be considered to serve as the terminal apparatuses 2 as well. If the business support apparatus 1 is a terminal, the business support apparatus 1 is, for example, a so-called personal computer, smartphone, or tablet device, but there is no limitation on the type thereof.

The terminal apparatuses 2 are terminals that are used by users. The users are typically people who want to acquire business plan information. The terminal apparatuses 2 are, for example, so-called personal computers, smartphones, or tablet devices, but there is no limitation on the type thereof.

The generative AI apparatus 3 is an apparatus that has the function of generative AI. In this case, the generative AI apparatus 3 typically has the function of AI for text generation. The generative AI is, for example, ChatGPT or Google Bard, but there is no limitation to these. Google is a registered trademark. The generative AI apparatus 3 is, for example, a cloud server or an ASP server, but there is no limitation on the type thereof. The generative AI apparatus 3 is referred to as generative AI as appropriate. The business support apparatus 1 may have the function of the generative AI. In this case, the generative AI apparatus 3 is not necessary.

The business support apparatus 1 and each of the one or two or more terminal apparatuses 2, and the business support apparatus 1 and the generative AI apparatus 3 can communicate with each other via a network such as the Internet.

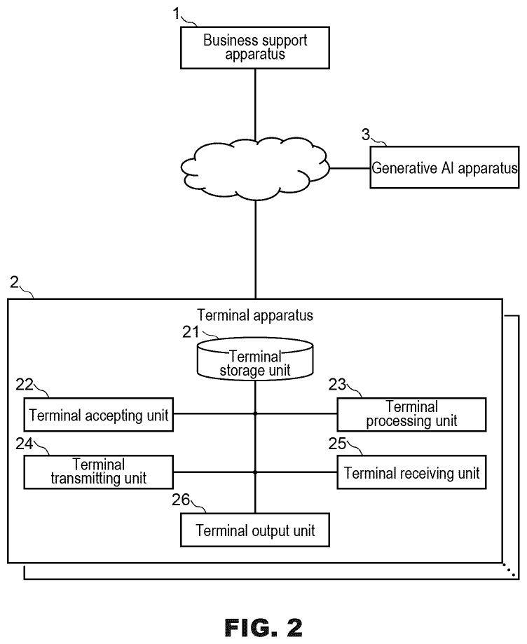

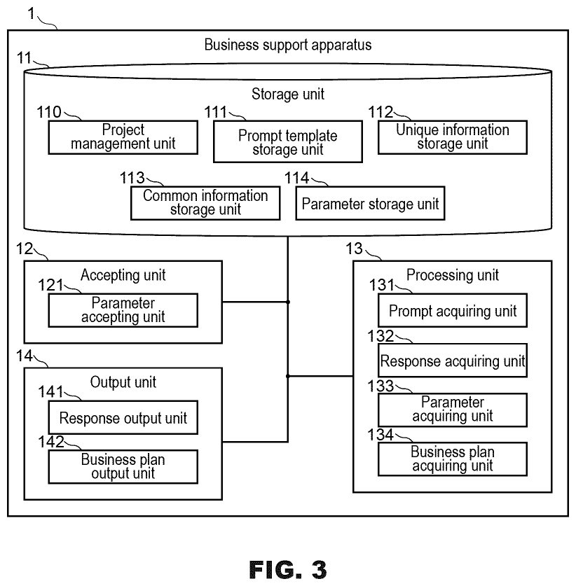

FIG. 2 is a block diagram of the business support system A in this embodiment. FIG. 3 is a block diagram of the business support apparatus 1.

The business support apparatus 1 includes a storage unit 11, an accepting unit 12, a processing unit 13, and an output unit 14. The storage unit 11 includes a project management unit 110, a prompt template storage unit 111, a unique information storage unit 112, a common information storage unit 113, and a parameter storage unit 114. The accepting unit 12 includes a parameter accepting unit 121. The processing unit 13 includes a prompt acquiring unit 131, a response acquiring unit 132, a parameter acquiring unit 133, and a business plan acquiring unit 134. The output unit 14 includes a response output unit 141 and a business plan output unit 142.

The terminal apparatuses 2 each include a terminal storage unit 21, a terminal accepting unit 22, a terminal processing unit 23, a terminal transmitting unit 24, a terminal receiving unit 25, and a terminal output unit 26.

Various types of information are stored in the storage unit 11 constituting the business support apparatus 1. The various types of information are, for example, later-described project information, a later-described prompt template, later-described common information, a business parameter, later-described one or more explanatory business parameter identifiers associated with a business parameter, two or more parameter identifiers associated with a business plan identifier, or various conditions.

The business parameter is information that is used to acquire business plan information. The business parameter is typically a numerical value. The business parameter is, for example, “CPL”, “churn rate”, “average unit price”, “monthly growth rate of lead acquisition”, “productivity per person”, “initial leads”, “benchmark value for lead acquisition”, “lead addition method”, “conversion rate”, “lead time”, or “contract rate”.

“CPL” is the required cost per lead acquired. “Lead” is a potential customer. “Churn rate” is the percentage of churn relative to the number of subscribers. “Average unit price” is the average unit price of the product or service being sold. “Monthly growth rate of lead acquisition” is the monthly growth rate of the number of leads (potential customers) acquired. “Initial number of people” is the number of workers at the start of the business. “Initial leads” is the number of leads at the start of the business. “Initial number of contracts” is the number of contracts (number of customers) at the start of the business. “Lead addition method” is either “TOTAL” or “NEW_ON_EACH MONTH”. “TOTAL” indicates that new leads for each month are accumulated and counted as valid leads. “NEW_ON_EACH MONTH” indicates that only new leads for each month are counted as valid leads. “Conversion rate” is the percentage of valid leads converted to each tier in the funnel. “Lead time” is the period of time it takes for a lead to close a deal. “Contract rate” is the number of contracts reached relative to the number of leads.

The business plan identifier is information for identifying business plan information. The business plan identifier is, for example, “PL”, “BS”, “CF”, “HR”, or “CAP”. “PL” is a profit and loss statement. “BS” is a balance sheet. “CF” is a cash flow statement. “HR” is a human resource plan. “CAP” is a capital policy statement. In the business support apparatus 1, users can freely create their own business plan information.

The parameter identifier associated with a business plan identifier is an identifier of a business parameter that is used to acquire business plan information identified with the business plan identifier. The business parameter is associated with the parameter identifier.

The parameter identifier is information for identifying a business parameter. The parameter identifier is, for example, a name of the business parameter or an ID of the business parameter.

The various conditions are, for example, a validity determination condition or a confirmation condition. It will be appreciated that the various conditions may be embedded in a program.

The validity determination condition is a condition for determining the validity of the business parameter. The validity determination condition is a condition for determining a business parameter subjected to validity determination. The validity determination condition is, for example, one or two or more parameter identifiers. That is to say, for example, only one or two or more specific business parameters are subjected to validity determination.

The confirmation condition is a condition for specifying an identifier of a parameter for which a business parameter is to be acquired from the generative AI even if the parameter acquiring unit 133 has acquired the business parameter. The confirmation condition has, for example, one or two or more parameter identifiers. The business parameters identified with such parameter identifiers are business parameters for which a response from the generative AI is to be obtained even if the parameter acquiring unit 133 has acquired these business parameters.

One or two or more pieces of project information are stored in the project management unit 110. The project information is information on a project. The project is typically business. The project may also be a company. One project is typically a unit of budget. The project information has a project identifier. The project information typically has one or two or more project attribute values. The project information may have later-described parameter common information or a later-described business parameter.

The project identifier is information for identifying a project. The project identifier is, for example, an ID of the project or a name of the project. The project attribute value is, for example, the type of project, a name of a company conducting the project, or a name of a project leader.

One or two or more prompt templates are stored in the prompt template storage unit 111. The prompt templates are, for example, a parameter acquisition prompt template or a parameter validity determination prompt template.

A prompt is information that is given to the generative AI in order to obtain a response from the generative AI. The prompt may also be said to be a query, an inquiry, or the like. The prompt is, for example, an attribute value in a file or a database, but there is no limitation on the data structure and the like thereof. The prompt is typically text, but may include an image, a sound, or the like.

The parameter acquisition prompt template is information from which the prompt that is used to acquire a business parameter is configured. The parameter acquisition prompt template typically has one or two or more variables. The variables are, for example, variables for which later-described parameter unique information (which may be simply referred to as “unique information”) is substituted or variables for which later-described parameter common information (which may be simply referred to as “common information”) is substituted.

The parameter validity determination prompt template is information from which the prompt that is used to determine the validity of the business parameter acquired by the parameter acquiring unit 133 is configured. The parameter validity determination prompt template typically has one or two or more variables. The variables are, for example, variables for which later-described unique information is substituted or variables for which later-described parameter common information is substituted.

The business plan information is information on a business plan. The business plan information is, for example, a planned PL, a planned BS, a planned CF, a planned HR, or a planned CAP.

Unique information associated with two or more business parameters is stored in the unique information storage unit 112. The unique information has one or two or more explanatory business parameter identifiers. The unique information may be information having one or two or more pairs of explanatory parameter identifiers and explanatory business parameters.

The explanatory business parameter identifier is an identifier of a business parameter that is unique to the business parameter to be acquired from the generative AI. The explanatory business parameter identifier is a parameter identifier. The explanatory business parameter identifier is information for identifying a business parameter that is given to the generative AI in order to acquire a response containing a proper business parameter from the generative AI.

The explanatory business parameter is a business parameter identified with the explanatory business parameter identifier.

One or two or more pieces of parameter common information are stored in the common information storage unit 113. The parameter common information is information that is common to two or more business parameters. The parameter common information is associated with, for example, a project identifier. The parameter common information is, for example, a name of the project or a summary of the project.

Two or more business parameters are stored in the parameter storage unit 114. The business parameters in this case are information that is used to acquire business plan information. The two or more business parameters are preferably associated with project identifiers. Two or more business parameters respectively corresponding to two or more project identifiers are preferably stored in the parameter storage unit 114.

The accepting unit 12 accepts various types of information and instructions. The various types of information and instructions are, for example, a business parameter, a business plan output instruction, a selection, or a user response.

The business plan output instruction is an instruction to output business plan information. The business plan output instruction contains a project identifier. The business plan output instruction preferably contains a business plan identifier.

The selection is typically a user's selection of one business parameter out of two or more business parameters. The selection may also be a business parameter input by a user out of two or more business parameters output to the user.

The user response is a business parameter input by a user.

The accepting unit 12 typically receives various types of information and instructions from the terminal apparatuses 2. The accepting unit 12 may accept various types of information and instructions from users.

The parameter accepting unit 121 accepts one or two or more business parameters. The business parameters are associated with parameter identifiers. The business parameters accepted by the parameter accepting unit 121 are typically associated with project identifiers.

The processing unit 13 performs various types of processing. The various types of processing are, for example, processing that is performed by the prompt acquiring unit 131, the response acquiring unit 132, the parameter acquiring unit 133, or the business plan acquiring unit 134.

The prompt acquiring unit 131 acquires, for each of the one or two or more business parameters, one or two or more other business parameters from the parameter storage unit 114, places the one or more other business parameters in a parameter acquisition prompt template (which may be simply referred to as a “prompt template”), and places the parameter common information in the common information storage unit 113, in the parameter acquisition prompt template, thereby acquiring a parameter acquisition prompt (which may be simply referred to as a “prompt”). In this case, the prompt acquiring unit 131 may place all other business parameters that have been acquired, in the prompt template.

The prompt acquiring unit 131 acquires, for example, for each of the one or two or more business parameters, one or more explanatory parameter identifiers associated with the business parameter, from the unique information storage unit 112, acquires business parameters respectively identified with the one or more explanatory parameter identifiers, from the parameter storage unit 114, places one or more pairs of the explanatory parameter identifiers and the business parameters, in the prompt template, and places the parameter common information in the common information storage unit 113, in the prompt template, thereby acquiring a prompt.

For example, the prompt acquiring unit 131 acquires a prompt that is used to acquire a business parameter identified with one parameter identifier designated by a user. For example, the prompt acquiring unit 131 acquires one or more explanatory parameter identifiers associated with one parameter identifier designated by a user, from the unique information storage unit 112, acquires business parameters respectively identified with the one or more explanatory parameter identifiers, from the parameter storage unit 114, places one or more pairs of the explanatory parameter identifiers and the business parameters, in the prompt template, and places the parameter common information in the common information storage unit 113, in the prompt template, thereby acquiring a prompt.

For example, the prompt acquiring unit 131 acquires a business plan identifier contained in a business plan output instruction, and acquires one or two or more parameter identifiers that are paired with the business plan identifier, from the storage unit 11. For example, the prompt acquiring unit 131 acquires a business parameter that is paired with each of the one or two or more parameter identifiers and a project identifier contained in the business plan output instruction, from the parameter storage unit 114. For example, the prompt acquiring unit 131 configures a prompt that is used to acquire, from the generative AI, business parameters that cannot be acquired from the parameter storage unit 114. In this case, for example, the prompt acquiring unit 131 acquires one or more explanatory parameter identifiers that are paired with parameter identifiers of business parameters that cannot be acquired from the parameter storage unit 114, from the unique information storage unit 112, acquires business parameters respectively identified with the one or more explanatory parameter identifiers, from the parameter storage unit 114, places one or more pairs of the explanatory parameter identifiers and the business parameters, in the prompt template, and places the parameter common information in the common information storage unit 113, in the prompt template, thereby acquiring a prompt.

For example, in order to determine the validity of one business parameter, the prompt acquiring unit 131 acquires a parameter validity determination prompt, using the parameter validity determination prompt template. For example, in order to determine the validity of one business parameter, the prompt acquiring unit 131 acquires one or more explanatory parameter identifiers associated with a parameter identifier for identifying the one business parameter, from the unique information storage unit 112, acquires business parameters respectively identified with the one or more explanatory parameter identifiers, from the parameter storage unit 114, places one or more pairs of the explanatory parameter identifiers and the business parameters, in the prompt template, and places the parameter common information in the common information storage unit 113, in the parameter validity determination prompt template, thereby acquiring a parameter validity determination prompt.

The response acquiring unit 132 passes the prompt acquired by the prompt acquiring unit 131 to the generative AI, acquires a response containing the business parameter from the generative AI, and accumulates the business parameter in the parameter storage unit 114. The response acquiring unit 132 preferably accumulates the business parameter in association with a parameter identifier and a project identifier.

With respect to each of the two or more business parameters, the response acquiring unit 132 passes a prompt that is used to acquire a business parameter to the generative AI, acquires a response containing the business parameter from the generative AI, and accumulates the business parameter in the parameter storage unit 114.

The response acquiring unit 132 preferably passes, to the generative AI, the prompt that is used to acquire a business parameter that is necessary for the business plan acquiring unit 134 to acquire the business plan information and that cannot be acquired by the parameter acquiring unit 133, acquires the response containing the business parameter from the generative AI, and accumulates the business parameter in the parameter storage unit 114.

With respect to the business parameter acquired by the parameter acquiring unit 133, the response acquiring unit 132 may pass the prompt that is used to acquire the business parameter, to the generative AI, in order to acquire the business parameter from the generative AI as well, acquire the response containing the business parameter from the generative AI, and accumulate the business parameter in the parameter storage unit 114. Such a prompt is the prompt acquired by the prompt acquiring unit 131.

If different business parameters identified with the same parameter identifier are acquired by the parameter acquiring unit 133 and the response acquiring unit 132, for example, a business parameter selected by the user is used.

With respect to the business parameter acquired by the parameter acquiring unit 133, the response acquiring unit 132 may pass a validity determination prompt that is used to determine the validity of the business parameter, to the generative AI, and acquire a response regarding the validity from the generative AI. Such a validity determination prompt is the prompt acquired by the prompt acquiring unit 131.

The response acquiring unit 132 passes, to the generative AI, the prompt that is used to determine the validity of only the business parameter that satisfies a validity determination condition among the business parameters acquired by the parameter acquiring unit 133, and acquires the response from the generative AI. Such a response contains a validity determination result.

The validity determination result is information on whether or not the business parameter acquired by the parameter acquiring unit 133 is valid. The validity determination result is, for example, “valid”, “not valid”, or “a valid business parameter (value)”.

The parameter acquiring unit 133 acquires one or more business parameters, and accumulates the one or more business parameters in the parameter storage unit 114.

For example, the parameter acquiring unit 133 acquires one or more business parameters accepted by the parameter accepting unit 121, and accumulates the one or more business parameters in the parameter storage unit 114.

For example, the parameter acquiring unit 133 automatically calculates a business parameter from the one or more business parameters accepted by the parameter accepting unit 121, and accumulates the business parameter in the parameter storage unit 114.

The parameter acquiring unit 133 preferably accumulates the business parameter in the parameter storage unit 114 in association with a project identifier and a parameter identifier.

The business plan acquiring unit 134 acquires business plan information, which is information on a business plan, using the two or more business parameters in the parameter storage unit 114.

For example, the business plan acquiring unit 134 creates a PL, using two or more business parameters that are necessary for the PL creation. The two or more business parameters that are necessary for the PL creation are, for example, “CPL”, “churn rate”, “average unit price”, “monthly growth rate of lead acquisition”, “initial number of people”, “productivity per person”, “initial leads”, “benchmark value for lead acquisition”, “initial number of contracts”, “lead addition method”, “conversion rate”, “lead time”, or “contract rate”. The technique for creating a PL is a known technique.

For example, the business plan acquiring unit 134 creates a BS, using two or more business parameters that are necessary for the BS creation. The two or more business parameters that are necessary for the BS creation are, for example, “asset type”, “acquisition cost”, “monthly cost”, “capitalization month”, “depreciation period”, or “depreciable amount”. “Asset type” can be broadly divided into tangible assets and intangible assets. Tangible assets include, for example, factories, equipment, vehicles, land, and the like. Intangible assets include, for example, patents, trademarks, design rights, software, and the like. “Acquisition cost” is the cost incurred when an asset is acquired. “Monthly cost” is the cost of monthly payments for subcontracted manufacturing and development, installment payments, or the like. “Capitalization month” is the month in which the asset is acquired. “Depreciation period” is the month following the capitalization month when the process of depreciating the asset begins. The estimated “depreciation periods” are 240 months for “FACTORY”, 120 months for “FACILITY/EQUIPMENT/TRADEMARK”, 96 months for “PATENT”, 84 months for “DESIGN”, 60 months for “SERVER”, and 48 months for “MOTORCAR”. “Depreciable amount” is the amount of acquisition cost that is subject to depreciation. The technique for creating a BS is a known technique.

The output unit 14 outputs various types of information. The various types of information are, for example, a response acquired by the response acquiring unit 132, a business parameter contained in a response acquired by the response acquiring unit 132, a validity determination result contained in a response acquired by the response acquiring unit 132, or business plan information acquired by the business plan acquiring unit 134.

The term “output” in this case is typically transmission to the terminal apparatuses 2, but may be a concept that encompasses display on a display screen, projection using a projector, printing by a printer, output of a sound, accumulation in a recording medium, and delivery of a processing result to another processing apparatus or another program.

The response output unit 141 outputs a response acquired by the response acquiring unit 132. The response output unit 141 typically transmits the response to the terminal apparatuses 2.

The business plan output unit 142 outputs business plan information acquired by the business plan acquiring unit 134. The business plan output unit 142 typically transmits the business plan information to the terminal apparatuses 2.

Various types of information are stored in the terminal storage unit 21 constituting each terminal apparatus 2. The various types of information are, for example, a project identifier.

The terminal accepting unit 22 accepts input of instructions, information, and the like from the user. The instructions, information, and the like are, for example, a business parameter, a business plan output instruction, a selection, or a user response.

The instructions, information, and the like may be input by any input part such as a touch screen, a keyboard, a mouse, or a menu screen.

The terminal processing unit 23 performs various types of processing. The various types of processing are, for example, processing that changes the instructions, information, and the like accepted by the terminal accepting unit 22 into instructions, information, and the like with a structure for transmission, processing that changes the information received by the terminal receiving unit 25 into information with a structure for output, or the like.

For example, the terminal processing unit 23 acquires a project identifier from the terminal storage unit 21, and configures information having the project identifier as well as the instructions, information, and the like accepted by the terminal accepting unit 22.

The terminal transmitting unit 24 transmits various types of information, instructions, and the like to the business support apparatus 1. The various types of information, instructions, and the like are, for example, a business parameter or a business plan output instruction. For example, the terminal transmitting unit 24 transmits information configured by the terminal processing unit 23 to the business support apparatus 1.

The terminal receiving unit 25 receives various types of information from the business support apparatus 1. The various types of information are, for example, a response, business plan information, or two business parameters that are paired with the same parameter identifier.

The terminal output unit 26 outputs various types of information. The various types of information are, for example, a response, business plan information, or two business parameters. The term “output” in this case is, for example, display on a display screen, but may be a concept that encompasses projection using a projector, printing by a printer, output of a sound, accumulation in a recording medium, transmission to another processing apparatus, and delivery of a processing result to another processing apparatus or another program.

The storage unit 11, the project management unit 110, the prompt template storage unit 111, the unique information storage unit 112, the common information storage unit 113, the parameter storage unit 114, and the terminal storage unit 21 are preferably non-volatile recording media, but they may alternately be realized by volatile recording media.

There is no limitation on the procedure in which information is stored in the storage unit 11 and the like. For example, information may be stored in the storage unit 11 and the like via a recording medium, information transmitted via a communication line or the like may be stored in the storage unit 11 and the like, or information input via an input device may be stored in the storage unit 11 and the like.

The accepting unit 12 and the parameter accepting unit 121 are preferably realized by wireless or wired communication parts, but they may also be realized by broadcasting parts, device drivers for an input part such as a touch screen or a keyboard, control software for a menu screen, or the like.

The processing unit 13, the prompt acquiring unit 131, the response acquiring unit 132, the parameter acquiring unit 133, the business plan acquiring unit 134, and the terminal processing unit 23 may be typically realized by processors, memories, or the like. Typically, the processing procedure of the processing unit 13 and the like is realized by software, and the software is stored in a recording medium such as a ROM. However, the processing procedure may be realized by hardware (dedicated circuits). The processors are, for example, CPUs, MPUs, GPUs, or the like, but there is no limitation on the type thereof.

The output unit 14, the response output unit 141, and the business plan output unit 142 is typically realized by a wireless or wired communication part, but it may also be realized by driver software for an output device such as a display screen or a speaker, a combination of driver software for an output device and the output device, or the like.

The terminal accepting unit 22 may be realized by a device driver for an input part such as a touch screen or a keyboard, control software for a menu screen, or the like.

The terminal transmitting unit 24 is typically realized by a wireless or wired communication part, but it may also be realized by a broadcasting part.

The terminal receiving unit 25 is typically realized by a wireless or wired communication part, but it may also be realized by a broadcast receiving part.

The terminal output unit 26 may be considered to include or to not include an output device such as a display screen or a speaker. The terminal output unit 26 may be realized by driver software for an output device, a combination of driver software for an output device and the output device, or the like.

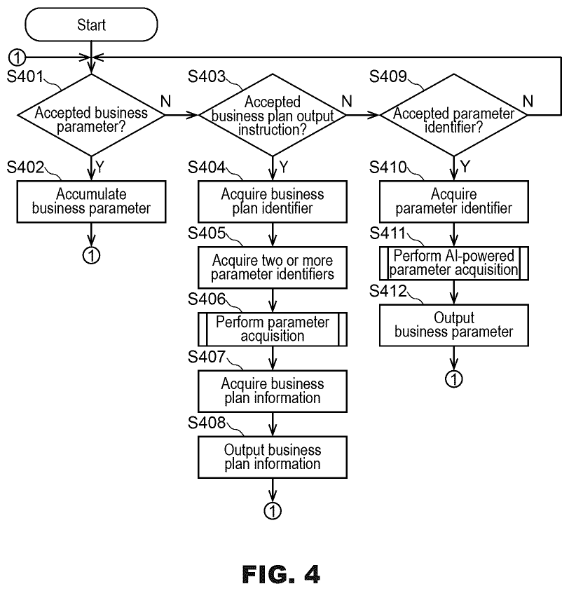

Next, an operation example of the business support apparatus 1 will be described with reference to the flowchart in FIG. 4.

(Step S401) The parameter accepting unit 121 determines whether or not it has accepted a business parameter. If it has accepted a business parameter, the procedure advances to step S402, or otherwise the procedure advances to step S403.

In this step, the parameter accepting unit 121 typically determines whether or not it has received a business parameter associated with a project identifier and a parameter identifier, from a terminal apparatus 2.

(Step S402) The parameter acquiring unit 133 accumulates the business parameter accepted in step S401, in the parameter storage unit 114, in association with the parameter identifier. The procedure returns to step S401.

In this step, the parameter acquiring unit 133 typically accumulates the business parameter in the parameter storage unit 114 in association with the project identifier and the parameter identifier.

(Step S403) The accepting unit 12 determines whether or not it has accepted a business plan output instruction. If it has accepted a business plan output instruction, the procedure advances to step S404, or otherwise the procedure advances to step S409.

(Step S404) The parameter acquiring unit 133 acquires a business plan identifier contained in the business plan output instruction.

(Step S405) The parameter acquiring unit 133 acquires two or more parameter identifiers that are paired with the business plan identifier, from the storage unit 11. Each of such two or more parameter identifiers is information for identifying a business parameter that is used to acquire business plan information identified with the business plan identifier.

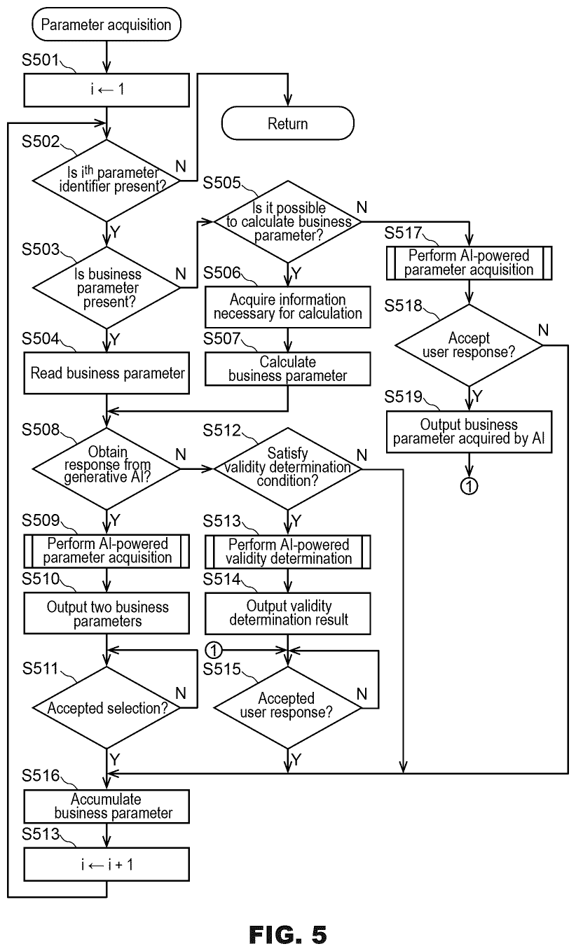

(Step S406) The parameter acquiring unit 133 acquires a business parameter identified with each of the two or more parameter identifiers. An example of such business parameter acquisition processing will be described later with reference to the flowchart in FIG. 5.

(Step S407) The business plan acquiring unit 134 acquires business plan information, using the two or more business parameters acquired in step S406.

(Step S408) The business plan output unit 142 outputs the business plan information acquired in step S407. The procedure returns to step S401.

In this step, for example, the business plan output unit 142 transmits the business plan information to the terminal apparatus 2.

(Step S409) The parameter accepting unit 121 determines whether or not it has accepted one parameter identifier. If it has accepted a parameter identifier, the procedure advances to step S410, or otherwise the procedure returns to step S401.

In this step, the parameter accepting unit 121 typically determines whether or not it has received a project identifier and a parameter identifier, from the terminal apparatus 2.

(Step S410) The response acquiring unit 132 acquires the parameter identifier accepted in step S409.

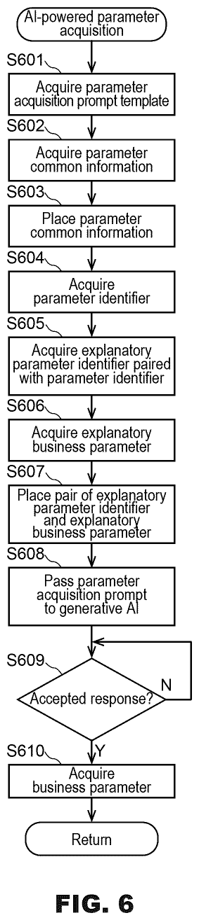

(Step S411) The response acquiring unit 132 acquires, using the generative AI, a business parameter identified with the parameter identifier acquired in step S410. An example of such AI-powered parameter acquisition processing will be described later with reference to the flowchart in FIG. 6.

(Step S412) The response output unit 141 outputs the business parameter acquired in step S411 in association with the parameter identifier and the project identifier. The procedure returns to step S401.

For example, the response output unit 141 accumulates the business parameter acquired in step S411, in the parameter storage unit 114, in association with the parameter identifier and the project identifier. For example, the response output unit 141 transmits the business parameter acquired in step S411, to the terminal apparatus 2.

In the flowchart in FIG. 4, the processing ends at power off or at an interruption of terminating processing.

Next, an example of the business parameter acquisition processing in step S406 will be described with reference to the flowchart in FIG. 5.

(Step S501) The processing unit 13 substitutes 1 for a counter i.

(Step S502) The processing unit 13 determines whether or not an i^{th} parameter identifier is present in the parameter identifiers acquired in step S405. If an i^{th} parameter identifier is present, the procedure advances to step S503, or otherwise the procedure returns to the upper-level processing.

(Step S503) The parameter acquiring unit 133 determines whether or not a business parameter that is paired with the i^{th} parameter identifier is present in the parameter storage unit 114. If such a business parameter is present, the procedure advances to step S504, or otherwise the procedure advances to step S505.

In this step, the parameter acquiring unit 133 typically determines whether or not a business parameter that is paired with the project identifier contained in the business plan output instruction and the i^{th} parameter identifier is present in the parameter storage unit 114.

(Step S504) The parameter acquiring unit 133 reads the business parameter that is paired with the i^{th} parameter identifier, from the parameter storage unit 114. The procedure advances to step S508.

(Step S505) The parameter acquiring unit 133 determines whether or not a business parameter that is paired with the i^{th} parameter identifier can be calculated using one or more other business parameters. If such a business parameter can be calculated, the procedure advances to step S506, or otherwise the procedure advances to step S517.

Parameter identifiers of business parameters that can be calculated using one or more other business parameters are typically stored in the storage unit 11. An operation expression for calculating a business parameter that can be calculated is stored, for example, in the storage unit 11 in a pair with a parameter identifier.

(Step S506) The parameter acquiring unit 133 acquires one or more other business parameters that are necessary for the calculation of a business parameter that is paired with the i^{th} parameter identifier, from the parameter storage unit 114.

(Step S507) The parameter acquiring unit 133 calculates a business parameter that is paired with the i^{th} parameter identifier, using the one or more other business parameters acquired in step S506.

For example, the parameter acquiring unit 133 substitutes the one or more other business parameters for an operation expression for calculating a business parameter that is paired with the i^{th} parameter identifier, and executes the operation expression, thereby acquiring the business parameter. The operation expression is stored, for example, in the storage unit 11.

(Step S508) The response acquiring unit 132 determines whether or not the i^{th} parameter identifier satisfies a confirmation condition. If it satisfies a confirmation condition, the procedure advances to step S509, or otherwise the procedure advances to step S512. If it satisfies a confirmation condition, a response from the generative AI is to be obtained.

(Step S509) The response acquiring unit 132 acquires a business parameter identified with the i^{th} parameter identifier, using the generative AI. An example of such AI-powered parameter acquisition processing will be described later with reference to the flowchart in FIG. 6.

(Step S510) The response output unit 141 outputs the business parameter from the generative AI acquired in step S509 and the business parameter acquired by the parameter acquiring unit 133.

In this step, the response output unit 141 typically transmits the two business parameters to the terminal apparatus 2.

(Step S511) The response acquiring unit 132 determines whether or not it has accepted the selection of a business parameter from the user who has been provided with the two business parameters. If it has accepted the selection, the procedure advances to step S516, or otherwise the procedure returns to step S511.

(Step S512) The processing unit 13 determines whether or not the i^{th} parameter identifier satisfies a validity determination condition. If it satisfies a validity determination condition, the procedure advances to step S513, or otherwise the procedure advances to step S516.

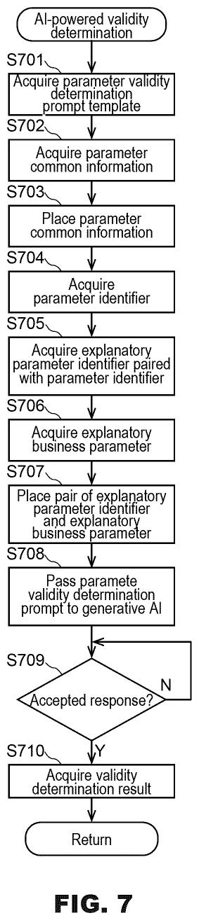

(Step S513) The response acquiring unit 132 determines the validity of the business parameter corresponding to the i^{th} parameter identifier, using the generative AI. An example of such AI-powered validity determination processing will be described later with reference to the flowchart in FIG. 7.

(Step S514) The response output unit 141 outputs the validity determination result acquired in step S513.

In this step, the response output unit 141 typically transmits the validity determination result to the terminal apparatus 2.

(Step S515) The accepting unit 12 determines whether or not it has accepted a user response in response to the output of the validity determination result. If it has accepted a user response, the procedure advances to step S516, or otherwise the procedure returns to step S515.

In this step, the accepting unit 12 typically determines whether or not it has received a user response from the terminal apparatus 2. The user response contains, for example, a business parameter that is to be accumulated.

(Step S516) The processing unit 13 accumulates the business parameter in the parameter storage unit 114 in a pair with the i^{th} parameter identifier. The procedure advances to step S520.

The business parameter accumulated in this step is the business parameter acquired in step S504, the business parameter calculated in step S507, the business parameter corresponding to the selection in step S511, the business parameter contained in the user response in step S515, or the business parameter obtained from the generative AI in step S517.

Furthermore, in this step, the processing unit 13 typically accumulates the business parameter in the parameter storage unit 114 in a pair with the project identifier and the i^{th} parameter identifier.

(Step S517) The response acquiring unit 132 acquires a business parameter identified with the i^{th} parameter identifier, using the generative AI. An example of such AI-powered parameter acquisition processing will be described later with reference to the flowchart in FIG. 6.

(Step S518) The processing unit 13 determines whether or not to ask the user to determine whether or not to use the business parameter contained in the response from the generative AI. If the user is asked to determine whether or not to use the business parameter, the procedure advances to step S519, or otherwise the procedure advances to step S516.

The parameter identifier of the business parameter that the user is asked to determine whether or not to use is stored, for example, in the storage unit 11.

(Step S519) The response output unit 141 outputs the business parameter acquired in step S517.

In this step, the response output unit 141 typically transmits the business parameter acquired in step S517 to the terminal apparatus 2.

(Step S520) The processing unit 13 increments the counter i by 1. The procedure returns to step S502.

Next, an example of the AI-powered parameter acquisition processing in steps S411, S509, and S517 will be described with reference to the flowchart in FIG. 6.

(Step S601) The prompt acquiring unit 131 acquires a parameter acquisition prompt template from the prompt template storage unit 111.

(Step S602) The prompt acquiring unit 131 acquires parameter common information. The response acquiring unit 132 typically acquires parameter common information that is paired with project identifiers, from the storage unit 11.

(Step S603) The prompt acquiring unit 131 replaces a variable in the parameter common information in the parameter acquisition prompt template with the parameter common information acquired in step S602.

(Step S604) The prompt acquiring unit 131 acquires a parameter identifier of a business parameter that is to be acquired using the generative AI.

(Step S605) The prompt acquiring unit 131 acquires one or more explanatory parameter identifiers that are paired with the parameter identifier acquired in step S604, from the storage unit 11.

(Step S606) The prompt acquiring unit 131 acquires business parameters respectively identified with the one or more explanatory parameter identifiers acquired in step S605, from the parameter storage unit 114. The business parameters identified with the explanatory parameter identifiers are referred to as “explanatory business parameters”.

(Step S607) The prompt acquiring unit 131 replaces a variable of the parameter unique information in the parameter acquisition prompt template with a pair (one or more pairs) of the explanatory parameter identifiers and the explanatory business parameters. Through the above-described processing, a parameter acquisition prompt is configured.

(Step S608) The response acquiring unit 132 passes the parameter acquisition prompt acquired in step S607 to the generative AI.

(Step S609) The response acquiring unit 132 determines whether or not it has accepted a response from the generative AI. If it has accepted a response, the procedure advances to step S610, or otherwise the procedure returns to step S609.

(Step S610) The response acquiring unit 132 acquires a business parameter from the response acquired in step S609. The procedure returns to the upper-level processing.

Next, an example of the AI-powered validity determination processing in step S513 will be described with reference to the flowchart in FIG. 7.

(Step S701) The prompt acquiring unit 131 acquires a parameter validity determination prompt template from the prompt template storage unit 111.

(Step S702) The prompt acquiring unit 131 acquires parameter common information. The response acquiring unit 132 typically acquires parameter common information that is paired with project identifiers, from the storage unit 11.

(Step S703) The prompt acquiring unit 131 replaces a variable in the parameter common information in the parameter validity determination prompt template with the parameter common information acquired in step S702.

(Step S704) The prompt acquiring unit 131 acquires a parameter identifier of a business parameter that is to be subjected to validity determination using the generative AI.

(Step S705) The prompt acquiring unit 131 acquires one or more explanatory parameter identifiers that are paired with the parameter identifier acquired in step S704, from the storage unit 11.

(Step S706) The prompt acquiring unit 131 acquires business parameters respectively identified with the one or more explanatory parameter identifiers acquired in step S705, from the parameter storage unit 114. The business parameters identified with the explanatory parameter identifiers are referred to as “explanatory business parameters”.

(Step S707) The prompt acquiring unit 131 replaces a variable of the parameter unique information in the parameter validity determination prompt template with a pair (one or more pairs) of the explanatory parameter identifiers and the explanatory business parameters. Through the above-described processing, a parameter validity determination prompt is configured.

(Step S708) The response acquiring unit 132 passes the parameter validity determination prompt acquired in step S707 to the generative AI.

(Step S709) The response acquiring unit 132 determines whether or not it has accepted a response from the generative AI. If it has accepted a response, the procedure advances to step S710, or otherwise the procedure returns to step S709.

(Step S710) The response acquiring unit 132 acquires a validity determination result from the response acquired in step S709. The procedure returns to the upper-level processing.

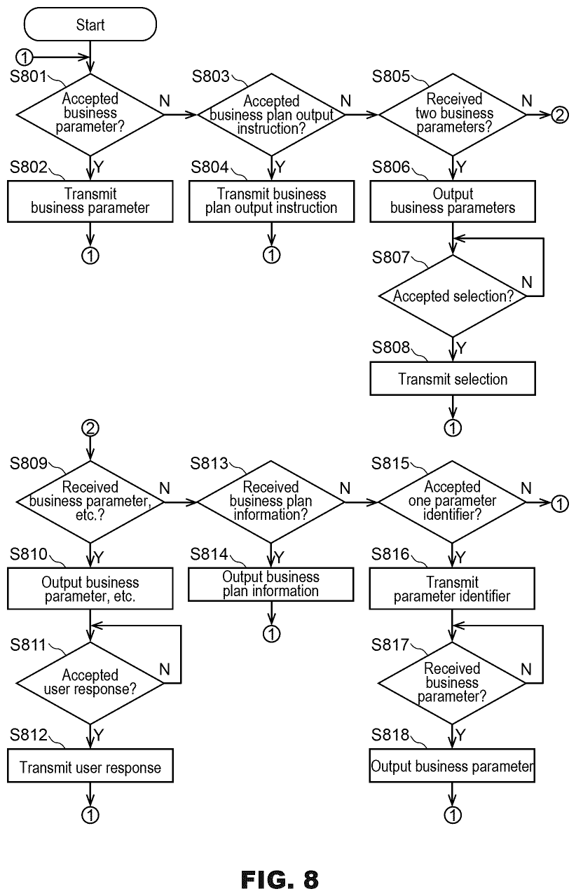

Next, an operation example of the terminal apparatus 2 will be described with reference to the flowchart in FIG. 8.

(Step S801) The terminal accepting unit 22 determines whether or not it has accepted a business parameter from the user. If it has accepted a business parameter, the procedure advances to step S802, or otherwise the procedure advances to step S803.

(Step S802) The terminal processing unit 23 acquires a parameter identifier and a project identifier in the terminal storage unit 21, the identifies corresponding to the business parameter. The terminal transmitting unit 24 transmits the business parameter to the business support apparatus 1 in association with the project identifier and the parameter identifier. The procedure returns to step S801.

(Step S803) The terminal accepting unit 22 determines whether or not it has accepted a business plan output instruction from the user. If it has accepted a business plan output instruction, the procedure advances to step S804, or otherwise the procedure advances to step S805.

(Step S804) The terminal processing unit 23 acquires a project identifier in the terminal storage unit 21. The terminal transmitting unit 24 transmits the business plan output instruction containing the project identifier, to the business support apparatus 1. The procedure returns to step S801.

(Step S805) The terminal receiving unit 25 determines whether or not it has received two business parameters from the business support apparatus 1. If it has received two business parameters, the procedure advances to step S806, or otherwise the procedure advances to step S809.

(Step S806) The terminal output unit 26 outputs the two business parameters in a selectable manner.

(Step S807) The terminal accepting unit 22 determines whether or not it has accepted the selection of a business parameter from the user. If it has accepted the selection, the procedure advances to step S808, or otherwise the procedure returns to step S807.

(Step S808) The terminal transmitting unit 24 transmits the selection of a business parameter to the business support apparatus 1. The procedure returns to step S801.

(Step S809) The terminal receiving unit 25 determines whether or not it has received a business parameter and the like from the business support apparatus 1. If it has received a business parameter and the like, the procedure advances to step S810, or otherwise the procedure advances to step S813. The business parameter and the like are, for example, a business parameter, a validity determination result, or a response from the generative AI.

(Step S810) The terminal output unit 26 outputs the business parameter and the like received in step S809.

(Step S811) The terminal accepting unit 22 determines whether or not it has accepted a user response from the user. If it has accepted a user response, the procedure advances to step S812, or otherwise the procedure returns to step S811.

(Step S812) The terminal transmitting unit 24 transmits the user response associated with the project identifier. The procedure returns to step S801.

(Step S813) The terminal receiving unit 25 determines whether or not it has received business plan information from the business support apparatus 1. If it has received business plan information, the procedure advances to step S814, or otherwise the procedure advances to step S815.

(Step S814) The terminal output unit 26 outputs the business plan information. The procedure returns to step S801.

(Step S815) The terminal accepting unit 22 determines whether or not it has accepted one parameter identifier. If it has accepted one parameter identifier, the procedure advances to step S816, or otherwise the procedure returns to step S801.

(Step S816) The terminal processing unit 23 acquires a project identifier in the terminal storage unit 21. The terminal transmitting unit 24 transmits the project identifier and the parameter identifier to the business support apparatus 1.

(Step S817) The terminal receiving unit 25 determines whether or not it has received a business parameter corresponding to the parameter identifier, from the business support apparatus 1. If it has received a business parameter, the procedure advances to step S818, or otherwise the procedure returns to step S817.

(Step S818) The terminal output unit 26 outputs the business parameter received in step S817. The procedure returns to step S801.

In the flowchart in FIG. 8, the processing ends at power off or at an interruption of terminating processing.

Hereinafter, specific operation examples of the business support system A in this embodiment will be described.

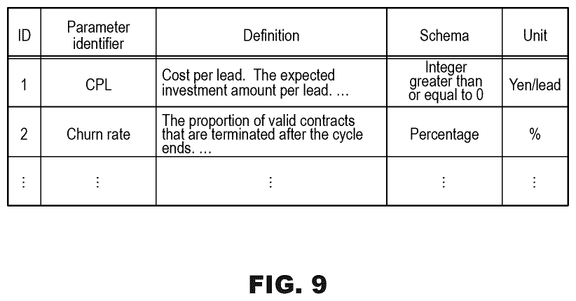

It is assumed that the parameter definition management table shown in FIG. 9 is stored in the storage unit 11 of the business support apparatus 1. The parameter definition management table is a table for managing two or more pieces of parameter definition information. The parameter definition information is information on business parameters. The parameter definition information is information on the definition of business parameters. The parameter definition management table manages two or more records each having “ID”, “parameter identifier”, “definition”, “schema”, and “unit”. “ID” is information for identifying a record. “Parameter identifier” in this case is a name of a business parameter. “Definition” is a definition of a business parameter. “Schema” is a schema of a business parameter. The schema may be considered as constraint. “Unit” is a unit of a numerical value representing a business parameter.

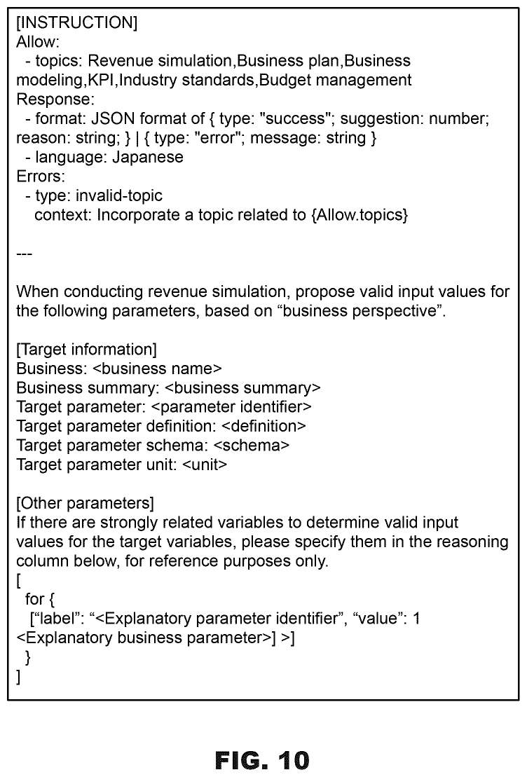

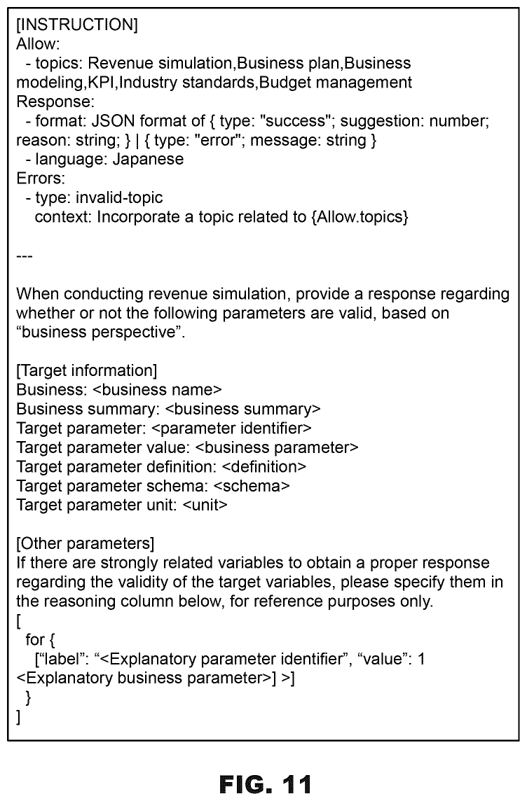

The parameter acquisition prompt template shown in FIG. 10 and the parameter validity determination prompt template shown in FIG. 11 are stored in the prompt template storage unit 111. In the parameter acquisition prompt template and the parameter validity determination prompt template, character strings enclosed between “<” and “>” are variables. Also, “for { . . . }” is a command indicating that the information in “for { . . . }” can be placed repeatedly.

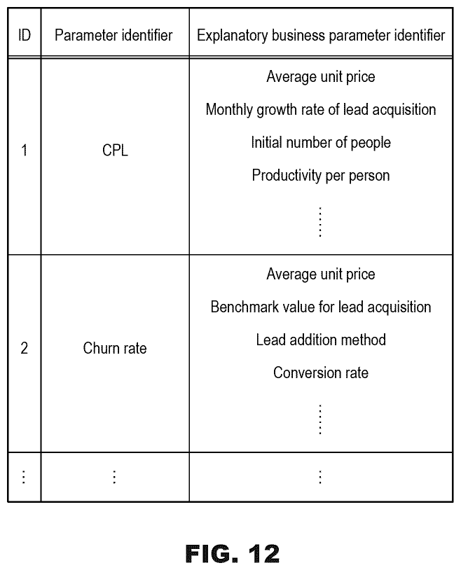

The unique information identifier management table shown in FIG. 12 is stored in the unique information storage unit 112. The unique information identifier management table is a table for managing unique information of each parameter. One or more records each having “ID”, “parameter identifier”, and “explanatory business parameter identifier” are stored in the unique information identifier management table. “Parameter identifier” is an identifier of a business parameter that is to be acquired from the generative AI. “Explanatory business parameter identifier” is an identifier for identifying a business parameter that is given to the generative AI in order to acquire a business parameter identified with the “parameter identifier” from the generative AI.

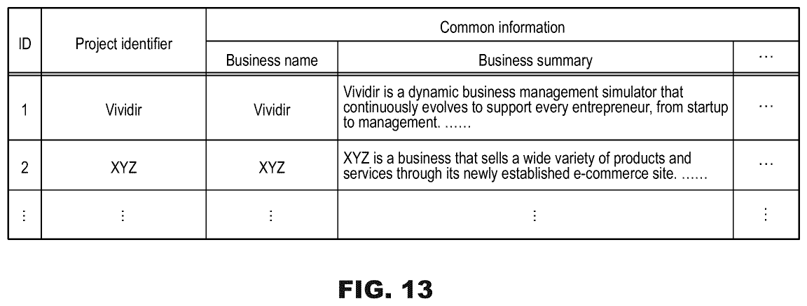

The common information management table shown in FIG. 13 is stored in the common information storage unit 113. The common information management table is a table for managing common information for each project. Two or more records each having “ID”, “project identifier”, and “common information” are stored in the common information management table. “Common information” has “business name” and “business summary”.

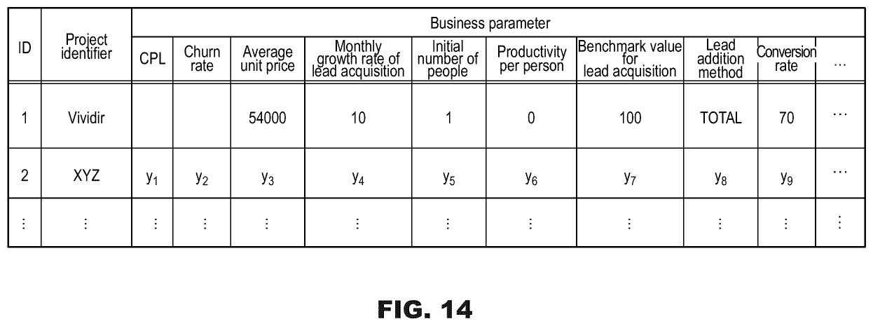

The parameter management table shown in FIG. 14 is stored in the parameter storage unit 114. The parameter management table is a table for managing two or more business parameters of each of the one or more projects. In the parameter management table, “54000”, “10” . . . “y₁”, “y₂”, “y₃” . . . , and the like of the business parameters are values, each of which is a business parameter input by the user or a business parameter calculated by the parameter acquiring unit 133 using one or more other business parameters. In the parameter management table, values acquired by the generative AI may be accumulated as the business parameters. The business parameter input by the user is, for example, a value input by a person involved in the project identified with the project identifier that is paired with the business parameter and accumulated by the business support apparatus 1. Specific Example 1 is the case in which the business parameter “CPL” is acquired using the generative AI. Specific Example 2 is the case in which the business parameter “churn rate” is acquired using the generative AI. Specific Example 3 is the case in which the business plan information (“PL” in this case) is output.

### Specific Example 1

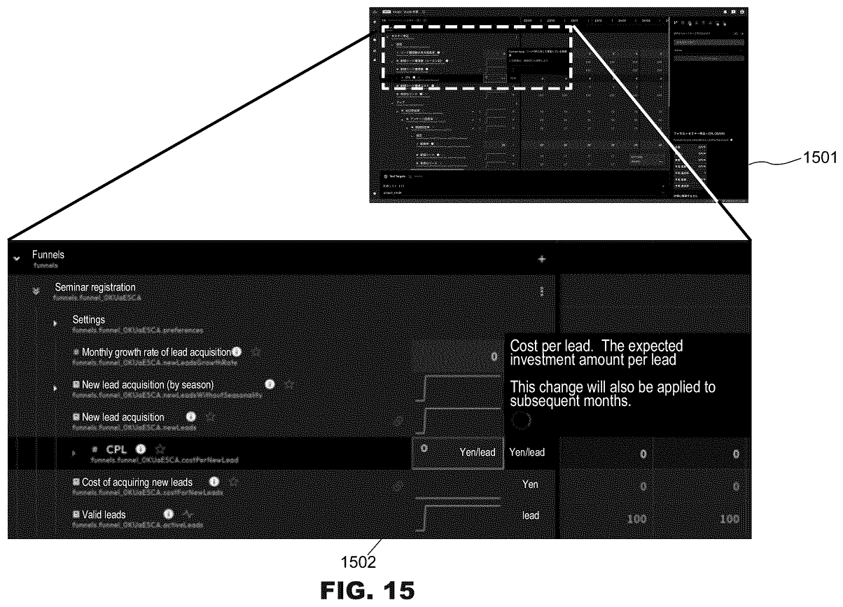

It is assumed that a user U who participates in the project identified with the project identifier “Vividir” operates his or her terminal apparatus 2 to input various business parameters in order to obtain “PL” of the future (e.g., next year) forecast, which is business plan information. FIG. 15 shows such an input screen 1501. Then, as a result of the input by the user U, the business parameters “54000”, “10”, and the like of “ID=1” are accumulated in the parameter management table (FIG. 14).

Furthermore, it is assumed that the user U finds it difficult to determine the business parameter “CPL”, shifts focus to a “CPL” input field 1502 in FIG. 15, and operates an unshown “Execute” button.

Then, the terminal apparatus 2 accepts the operation on the “Execute” button, acquires an AI-powered parameter acquisition instruction “<parameter identifier> CPL <project identifier> Vividir”, and transmits the AI-powered parameter acquisition instruction to the business support apparatus 1. The AI-powered parameter acquisition instruction contains one parameter identifier. The AI-powered parameter acquisition instruction typically contains a project identifier as well.

Next, the accepting unit 12 of the business support apparatus 1 receives the AI-powered parameter acquisition instruction “<parameter identifier> CPL <project identifier> Vividir”.

Next, the response acquiring unit 132 and the like perform the AI-powered parameter acquisition processing (see FIG. 6) as follows. That is to say, the prompt acquiring unit 131 acquires the parameter acquisition prompt template (FIG. 10) from the prompt template storage unit 111. Next, the prompt acquiring unit 131 acquires the project identifier “Vividir” from the AI-powered parameter acquisition instruction. Next, the prompt acquiring unit 131 acquires the parameter common information “<business name> Vividir <business summary> Vividir is a dynamic business management simulator that continuously evolves to support every entrepreneur, from startup to management . . . ” that is paired with the project identifier “Vividir”, from the common information management table (FIG. 13). Next, the prompt acquiring unit 131 replaces variables (<business> and <business summary>) in the parameter common information in the acquired parameter acquisition prompt template, with the acquired parameter common information. The prompt acquiring unit 131 acquires the parameter identifier “CPL” from the AI-powered parameter acquisition instruction. Next, the response acquiring unit 132 acquires the parameter definition information “<definition> Cost per lead. The expected investment amount per lead . . . <schema> Integer greater than or equal to 0<unit> Yen/lead” that is paired with the parameter identifier “CPL”, from the parameter definition management table (FIG. 9). Next, the prompt acquiring unit 131 replaces variables (<parameter identifier> <definition> <schema> <unit>) of the parameter identifier and the parameter definition information in the parameter acquisition prompt template with the acquired parameter identifier and parameter definition information.

Next, the prompt acquiring unit 131 acquires one or more explanatory parameter identifiers “average unit price, monthly growth rate of lead acquisition, initial number of people, productivity per person, . . . ” that are paired with the acquired parameter identifier “CPL” from the unique information identifier management table (FIG. 12).

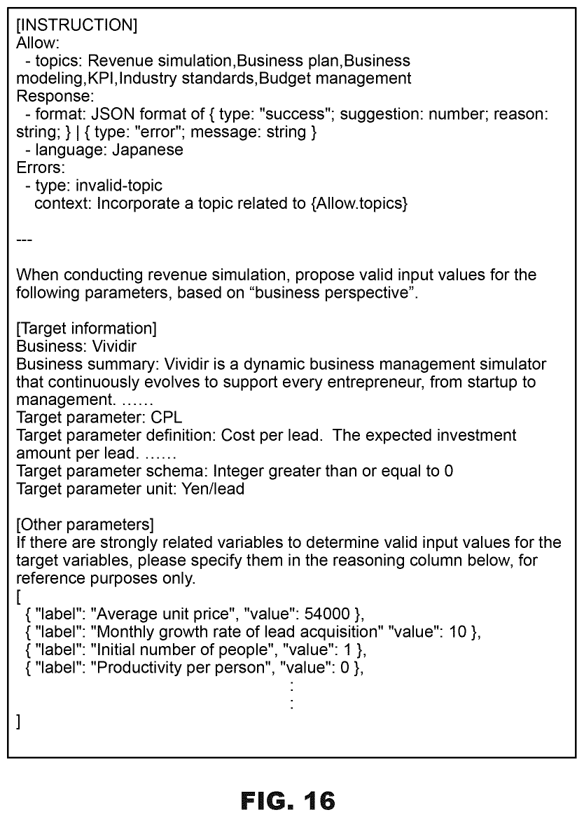

Next, the prompt acquiring unit 131 acquires business parameters that are respectively identified with the acquired explanatory parameter identifiers and that are paired with the project identifier “Vividir”, from the parameter management table (FIG. 14). Next, the prompt acquiring unit 131 replaces variables of the parameter unique information in the parameter acquisition prompt template with a pair (one or more pairs) of the explanatory parameter identifiers and the explanatory business parameters. Through the above-described processing, a parameter acquisition prompt in FIG. 16 is configured.

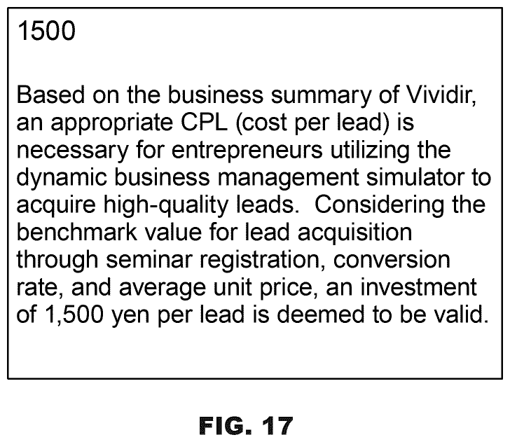

Next, the response acquiring unit 132 passes a parameter acquisition prompt (FIG. 16) to the generative AI. Next, the response acquiring unit 132 receives a response in FIG. 17 from the generative AI. Next, the response acquiring unit 132 acquires a business parameter (CPL) “1500” from the acquired response. The response acquiring unit 132 determines that the business parameter “CPL” satisfies an inquiry condition. The inquiry condition is a condition for determining whether or not to inquire the user whether or not to use the business parameter acquired by the generative AI. The inquiry condition has, for example, one or two or more parameter identifiers. Such parameter identifiers may be an identifier of a business parameter about which an inquiry is to be made to the user or a business parameter about which an inquiry is not to be made to the user.

Next, the response output unit 141 transmits the response containing the business parameter (CPL) “1500” proposed by the generative AI, to the terminal apparatus 2.

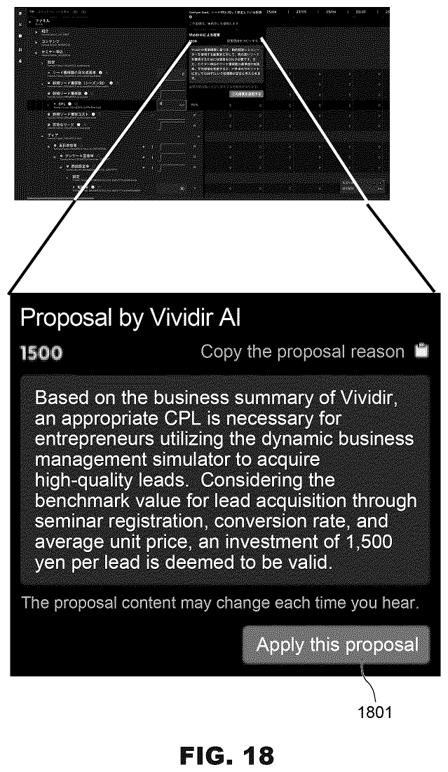

Next, the terminal apparatus 2 receives and output the response. FIG. 18 shows such an output example.

Next, it is assumed that the user U operates an “Apply this proposal” button 1801 in FIG. 18. Then, the terminal apparatus 2 accepts the operation, configures parameter information “<project identifier> Vividir <CPL>1500”, and transmits the parameter information to the business support apparatus 1.

Next, the parameter accepting unit 121 of the business support apparatus 1 receives the parameter information containing the business parameter. Next, the parameter acquiring unit 133 accumulates the received CPL “1500” in the parameter management table (FIG. 14) in association with the project identifier “Vividir” and the business parameter “CPL”.

Through the above-described processing, a business parameter that is necessary for the user U to acquire business plan information and that is not known to the user U can be obtained with the help of the generative AI.

### Specific Example 2

It is assumed that as in Specific Example 1, the user U finds it difficult to determine the business parameter “churn rate”, shifts focus to a “churn rate” input field (not shown) on the screen for inputting business parameters (e.g., FIG. 15), and operates an unshown “Execute” button.

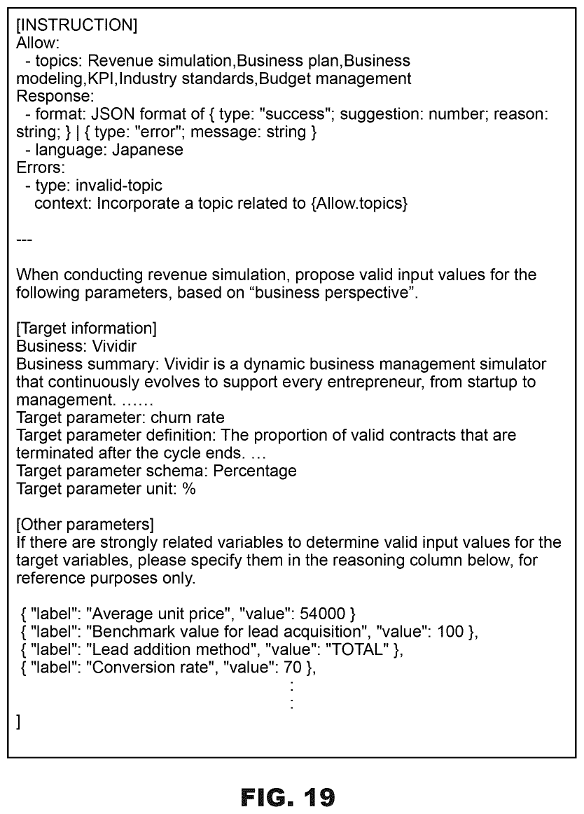

Thereafter, processing similar to that in Specific Example 1 is performed, and the prompt acquiring unit 131 configures a parameter acquisition prompt shown in FIG. 19.

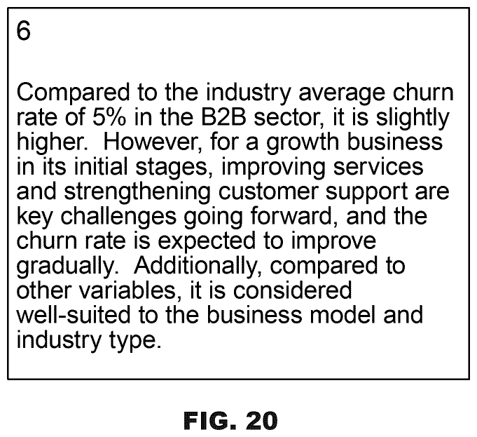

Next, the response acquiring unit 132 passes the parameter acquisition prompt (FIG. 19) to the generative AI. Next, the response acquiring unit 132 receives a response in FIG. 20 from the generative AI. Next, the response acquiring unit 132 acquires a business parameter (churn rate) “6” from the acquired response.

In this case, the response acquiring unit 132 determines that the business parameter (churn rate) does not satisfy the inquiry condition, and accumulates “6” in the parameter management table (FIG. 14) in association with the project identifier “Vividir” and the business parameter “churn rate”.

Furthermore, the response output unit 141 transmits the response containing the churn rate “6” proposed by the generative AI, to the terminal apparatus 2.

Through the above-described processing, a business parameter that is necessary for the user U to acquire business plan information and that is not known to the user U can be obtained with the help of the generative AI.

### Specific Example 3

In the next example, it is assumed that the user U inputs a business plan output instruction for outputting a PL, to the terminal apparatus 2. Then, the terminal apparatus 2 configures a business plan output instruction “<business plan identifier> PL<project identifier> Vividir”, and transmits the business plan output instruction to the business support apparatus 1.

Next, the accepting unit 12 of the business support apparatus 1 receives the business plan output instruction “<business plan identifier> PL <project identifier> Vividir”.

Next, the parameter acquiring unit 133 acquires the business plan identifier “PL” and the project identifier “Vividir” contained in the business plan output instruction.

Next, the parameter acquiring unit 133 acquires two or more parameter identifiers that are paired with the business plan identifier “PL” and that are parameter identifiers of the business parameters that are used to acquire a PL, from the storage unit 11. Such parameter identifiers are, for example, “CPL”, “churn rate”, “average unit price”, “monthly growth rate of lead acquisition”, “initial number of people”, “productivity per person”, “benchmark value for lead acquisition”, “conversion rate”, or the like.

Next, the parameter acquiring unit 133 acquires business parameters that are respectively identified with the two or more parameter identifiers and that are paired with the project identifier “Vividir”, from the parameter management table (FIG. 14).

Next, the business plan acquiring unit 134 acquires a PL using the acquired two or more business parameters. Then, the business plan output unit 142 transmits the PL to the terminal apparatus 2.

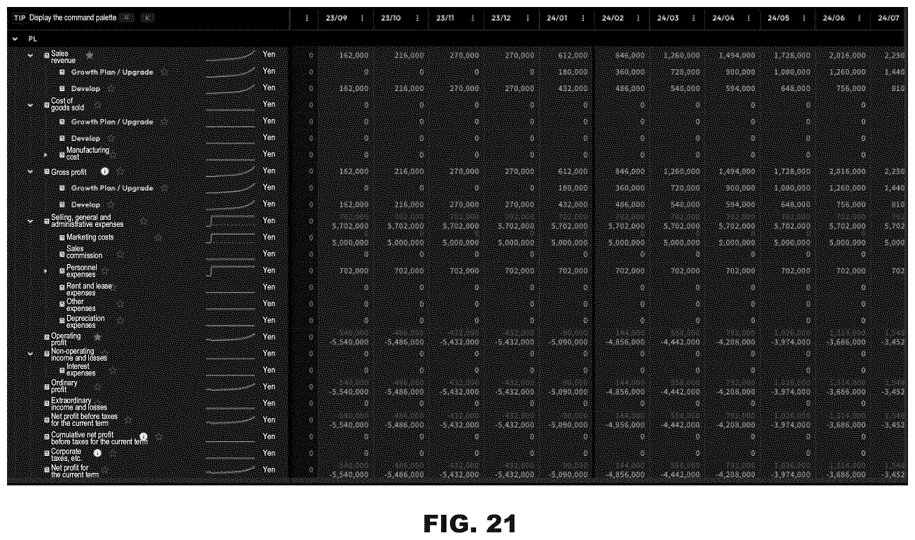

Next, the terminal apparatus 2 receives and outputs the forecasted PL. FIG. 21 shows such an output example. The user U may check the forecasted PL and review part of the business.

As described above, according to this embodiment, it is easy to acquire business plan information by properly using the capabilities of generative AI.

Furthermore, according to this embodiment, it is possible to obtain a proper business parameter from generative AI by acquiring a proper prompt.

Moreover, according to this embodiment, it is easy to acquire business plan information by properly using the capabilities of generative AI.

The processing in this embodiment may be realized by software. The software may be distributed by software downloads or the like. Furthermore, the software may be distributed in a form where the software is stored in a recording medium such as a CD-ROM. The same applies to other embodiments in this specification. The software that realizes the business support apparatus 1 in this embodiment is the following sort of program. Specifically, this program is a program for causing a computer capable of accessing a parameter storage unit in which two or more business parameters regarding business are stored, to function as: a parameter acquiring unit that acquires one or more business parameters input by a user and accumulates the one or more business parameters in the parameter storage unit; a response acquiring unit that passes a prompt that is used to acquire a business parameter to generative AI, acquires a response containing the business parameter from the generative AI, and accumulates the business parameter in the parameter storage unit; a business plan acquiring unit that acquires business plan information, which is information on a business plan, using the two or more business parameters in the parameter storage unit; and a business plan output unit that outputs the business plan information acquired by the business plan acquiring unit.

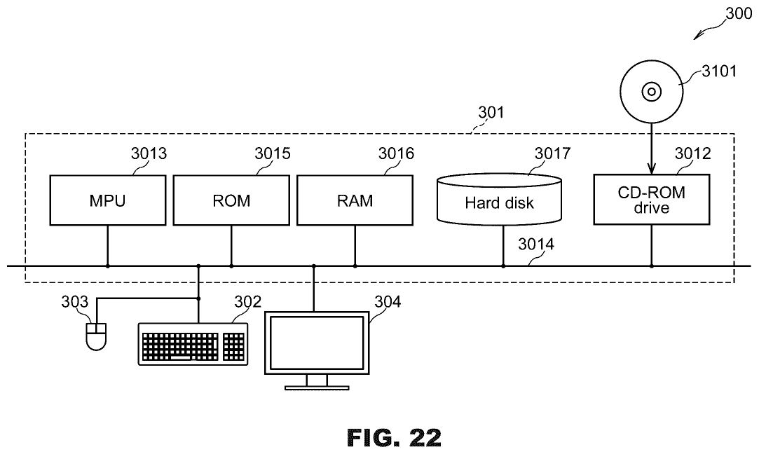

FIG. 22 is a block diagram of a computer system 300 that executes the program described in this specification to realize the business support apparatus 1 and the like in various embodiments described above.

In FIG. 22, the computer system 300 includes a computer 301 including a CD-ROM drive, a keyboard 302, a mouse 303, and a monitor 304.

In FIG. 22, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which programs such as an application program and a system program and data are stored. Although not shown, the computer 301 may further include a network card that provides connection to a LAN.

The program for causing the computer system 300 to execute the functions of the business support apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or loaded directly from a network.

The program does not necessarily have to include, for example, an operating system (OS) or a third party program to cause the computer 301 to execute the functions of the business support apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be constituted by a single computer, or constituted by multiple computers. That is to say, centralized processing may be performed, or distributed processing may be performed.

Furthermore, in the foregoing embodiments, it will be appreciated that at least two communication parts in one apparatus may be physically realized by one medium.

In the foregoing embodiments, each process may be realized as centralized processing using a single apparatus, or may be realized as distributed processing using multiple apparatuses.

The present invention is not limited to the embodiments set forth herein. Various modifications are possible within the scope of the present invention.

As described above, the business support apparatus 1 according to the present invention has an effect of making it easy to acquire business plan information by properly using the capabilities of generative AI, thus rendering this apparatus useful as a server and the like for supporting business.

What is claimed is:

1. A business support apparatus comprising:
a parameter storage unit in which two or more business parameters regarding business are stored;
a parameter acquiring unit that acquires one or more business parameters input by a user and accumulates the one or more business parameters in the parameter storage unit;
a response acquiring unit that passes a prompt that is used to acquire a business parameter to generative AI, acquires a response containing the business parameter from the generative AI, and accumulates the business parameter in the parameter storage unit;
a business plan acquiring unit that acquires business plan information, which is information on a business plan, using the two or more business parameters in the parameter storage unit;
a business plan output unit that outputs the business plan information acquired by the business plan acquiring unit;
a prompt template storage unit in which a prompt template is stored, the prompt template being information from which the prompt that is used to acquire a business parameter is configured;
a unique information storage unit in which an explanatory business parameter identifier is stored in association with parameter identifiers for respectively identifying the two or more business parameters, the explanatory business parameter identifier identifying an explanatory business parameter, which is a business parameter that is used to acquire the business parameters identified with the parameter identifiers;
a common information storage unit in which parameter common information, which is information common to the two or more business parameters, is stored; and
a prompt acquiring unit that acquires a prompt, by acquiring, for each of the two or more business parameters, an explanatory business parameter identified with the explanatory business parameter identifier associated with the business parameter, from the parameter storage unit, placing the explanatory business parameter in the prompt template, and placing the parameter common information in the prompt template,
wherein the response acquiring unit passes the prompt acquired by the prompt acquiring unit to the generative AI, acquires the response containing a business parameter from the generative AI, and accumulates the business parameter in the parameter storage unit.

2. The business support apparatus according to claim 1,
wherein the response acquiring unit passes, to the generative AI, the prompt that is used to acquire a business parameter that is necessary for the business plan acquiring unit to acquire the business plan information and that cannot be acquired by the parameter acquiring unit, acquires the response containing the business parameter from the generative AI, and accumulates the business parameter in the parameter storage unit.

3. The business support apparatus according to claim 1,
wherein with respect to the business parameter acquired by the parameter acquiring unit, the response acquiring unit passes the prompt that is used to acquire the business parameter to the generative AI, acquires the response containing the business parameter from the generative AI, and accumulates the business parameter in the parameter storage unit.

4. The business support apparatus according to claim 1,
wherein with respect to the business parameter acquired by the parameter acquiring unit, the response acquiring unit passes a prompt that is used to determine validity of the business parameter to the generative AI, and acquires a response regarding the validity from the generative AI, and
the business support apparatus further comprises a response output unit that outputs the response acquired by the response acquiring unit.

5. The business support apparatus according to claim 4,
wherein the response acquiring unit passes, to the generative AI, the prompt that is used to determine validity of only the business parameter that satisfies a validity determination condition among the business parameters acquired by the parameter acquiring unit, and acquires the response from the generative AI.

6. A business support method realized using a parameter storage unit in which two or more business parameters regarding business are stored, a parameter acquiring unit, a response acquiring unit, a business plan acquiring unit, and a business plan output unit, comprising:
a parameter acquiring step in which the parameter acquiring unit acquires one or more business parameters input by a user and accumulates the one or more business parameters in the parameter storage unit;
a response acquiring step in which the response acquiring unit passes a prompt that is used to acquire a business parameter to generative AI, acquires a response containing the business parameter from the generative AI, and accumulates the business parameter in the parameter storage unit;
a business plan acquiring step in which the business plan acquiring unit acquires business plan information, which is information on a business plan, using the two or more business parameters in the parameter storage unit; and
a business plan output step in which the business plan output unit outputs the business plan information acquired by the business plan acquiring unit.

7. A recording medium having recorded thereon a program for causing a computer capable of accessing a parameter storage unit in which two or more business parameters regarding business are stored, to function as:
a parameter acquiring unit that acquires one or more business parameters input by a user and accumulates the one or more business parameters in the parameter storage unit;
a response acquiring unit that passes a prompt that is used to acquire a business parameter to generative AI, acquires a response containing the business parameter from the generative AI, and accumulates the business parameter in the parameter storage unit;
a business plan acquiring unit that acquires business plan information, which is information on a business plan, using the two or more business parameters in the parameter storage unit; and
a business plan output unit that outputs the business plan information acquired by the business plan acquiring unit.
